(19) United States
(12) Patent Application Publication
(10) Pub. No.: US 2025/0004091 A1
(43) Pub. Date: Jan. 2, 2025

(54) CALIBRATING A TRANSPARENT WEARABLE DISPLAY

(71) Applicant: Telefonaktiebolaget LM Ericsson (publ), Stockholm (SE)

(72) Inventors: Alexander HUNT, Tygelsjö (SE); Gang ZOU, Lund (SE); Sunny SHARMA, Limhamn (SE); Fredrik DAHLGREN, Lund (SE); Florent TORRES, Malmö (SE)

(21) Appl. No.: 18/570,744

(22) PCT Filed: Jul. 1, 2021
(86) PCT No.: PCT/EP2021/068200

§ 371 Date: Dec. 15, 2023

(51) Int. Cl. G01S 5/02; G02B 27/00; G02B 27/01; G06F 3/01

(52) U.S. Cl. CPC G01S 5/021; G02B 27/0093; G02B 27/017; G06F 3/011

(57) ABSTRACT

It is provided a method for calibrating a transparent wearable display configured to be used in parallel with an external display. The method is performed by a calibration device. The method includes the steps of: performing a first calibration to define an indicated position on the external display at least partly based on a direction of the wearable display; determining an indicated position on the external display, based on the direction of the wearable display, the indicated position corresponding to a user interface element shown on the external display; determining an element position on the external display corresponding to a centre position of the user interface element; and performing a translational adjustment of calibration of how the indicated position is determined on the external display based on the direction of the wearable display, to move the indicated position closer to the element position.

### TECHNICAL FIELD

The present disclosure relates to the field of wearable displays and in particular to calibrating a transparent wearable display.

### BACKGROUND

Wearable displays have increased in popularity lately. Wearable displays can be used to show content in parallel to the user watching other real-world or rendered content. For instance, wearable displays can be implemented using smart glasses. Such devices often contain a transparent display, using which auxiliary content is rendered, such as notifications of an event, context information, etc.

When a direction of such a display is to be determined, this is often based on accelerometers and gyros in an Inertial Measurement Unit (IMU). However, the direction determination tends to drift over time, also known as sensor drift.

To compensate for the sensor drift, the wearable device needs to be calibrated again and again over time.

### SUMMARY

One object is to improve how calibration of a wearable display is performed.

According to a first aspect, it is provided a method for calibrating a transparent wearable display configured to be used in parallel with an external display. The method is performed by a calibration device. The method comprises the steps of: performing a first calibration to define an indicated position on the external display at least partly based on a direction of the wearable display; determining an indicated position on the external display, based on the direction of the wearable display, the indicated position corresponding to a user interface element shown on the external display; determining an element position on the external display corresponding to a centre position of the user interface element; and performing a translational adjustment of calibration of how the indicated position is determined on the external display based on the direction of the wearable display, to move the indicated position closer to the element position.

The step of performing a translational calibration may comprise moving the indicated position towards the element position, by a distance being the distance between the indicated position and the element position multiplied by a nudging factor.

The method may further comprise: recalibrating how the indicated position on the external display is based on the direction of the wearable display.

The step of recalibrating may be repeated, in which case, in each iteration of the step of recalibrating, a time interval until the next iteration of the step of recalibrating is determined based on a most recently determined sensor drift.

The step of recalibrating may comprise the sub-steps of: rendering, on the external display, an image comprising a high-luminance area and a low-luminance area; detecting, using a narrow-beam light sensor, fixedly mounted in relation to the wearable display, whether the wearable display is directed to the high-luminance area or the low-luminance area; and repeating the rendering, with a different image, and detecting until the direction of the wearable display is determined with sufficient accuracy.

For each iteration, the step of rendering an image may comprise rendering, over time, a smaller area, being a high-luminance area or a low-luminance area in the direction that the wearable display is directed.

The step of rendering an image may comprise interjecting the image as a single frame in main content shown on the external display.

The step of recalibrating may comprise the sub-steps of: rendering, on the external display, a calibration marker; determining, using a camera, fixedly mounted in relation to the wearable display, a position of the calibration marker in relation to the direction of the wearable display; and recalibrating how the indicated position on the external display is based on the direction of the wearable display based on the position of the calibration marker in relation to the direction of the wearable display.

The step of rendering a calibration marker may comprise overlaying the calibration marker in main content shown on the external display.

The step of recalibrating may comprise the sub-steps of: determining, using an determination of angle-of-arrival and/or angle-of-departure between a first radio transceiver, fixedly mounted in relation to the wearable display, and a second radio transceiver fixedly mounted in relation to the external display, a deviation of how the indicated position on the external display is defined by the direction of the wearable display compared to a previously calibrated state; and recalibrating to eliminate the deviation.

The step of recalibrating may comprise the sub-steps of: determining, using an inertial measurement unit, IMU, fixedly mounted in relation to the wearable display, a translational movement of the wearable display in relation to the external monitor; and recalibrating how the indicated position on the external display is defined by the direction of the wearable display based on the translational movement.

According to a second aspect, it is provided a calibration device for calibrating a transparent wearable display configured to be used in parallel with an external display. The calibration device comprises: a processor; and a memory storing instructions that, when executed by the processor, cause the calibration device to: perform a first calibration to define an indicated position on the external display at least partly based on a direction of the wearable display; determine an indicated position on the external display, based on the direction of the wearable display, the indicated position corresponding to a user interface element shown on the external display; determine an element position on the external display corresponding to a centre position of the user interface element; and perform a translational adjustment of calibration of how the indicated position is determined on the external display based on the direction of the wearable display, to move the indicated position closer to the element position.

The instructions to perform a translational calibration may comprise instructions that, when executed by the processor, cause the calibration device to move the indicated position towards the element position, by a distance being the distance between the indicated position and the element position multiplied by a nudging factor.

The calibration device may further comprise instructions that, when executed by the processor, cause the calibration device to: recalibrate how the indicated position on the external display is based on the direction of the wearable display.

The instructions to recalibrate may be repeated, in which case, in each iteration of the instructions to recalibrate, a time interval until the next iteration of the instructions to recalibrate is determined based on a most recently determined sensor drift.

The instructions to recalibrate may comprise instructions to: render, on the external display, an image comprising a high-luminance area and a low-luminance area; detect, using a narrow-beam light sensor, fixedly mounted in relation to the wearable display, whether the wearable display is directed to the high-luminance area or the low-luminance area; and repeat the instructions to render, with a different image, and to detect until the direction of the wearable display is determined with sufficient accuracy.

For each iteration, the instructions to render an image may comprise instructions that, when executed by the processor, cause the calibration device to render, over time, a smaller area, being a high-luminance area or a low-luminance area in the direction that the wearable display is directed.

The instructions to render an image may comprise instructions that, when executed by the processor, cause the calibration device to interject the image as a single frame in main content shown on the external display.

The instructions to recalibrate may comprise the instructions that, when executed by the processor, cause the calibration device to: render, on the external display, a calibration marker; determine, using a camera, fixedly mounted in relation to the wearable display, a position of the calibration marker in relation to the direction of the wearable display; and recalibrate how the indicated position on the external display is based on the direction of the wearable display based on the position of the calibration marker in relation to the direction of the wearable display.

The instructions to render a calibration marker may comprise instructions that, when executed by the processor, cause the calibration device to overlay the calibration marker in main content shown on the external display.

The instructions to recalibrate may comprise instructions that, when executed by the processor, cause the calibration device to: determine, using an determination of angle-of-arrival and/or angle-of-departure between a first radio transceiver, fixedly mounted in relation to the wearable display, and a second radio transceiver fixedly mounted in relation to the external display, a deviation of how the indicated position on the external display is defined by the direction of the wearable display compared to a previously calibrated state; and recalibrate to eliminate the deviation.

The instructions to recalibrate may comprise instructions that, when executed by the processor, cause the calibration device to: determine, using an inertial measurement unit, IMU, fixedly mounted in relation to the wearable display, a translational movement of the wearable display in relation to the external monitor; and recalibrate how the indicated position on the external display is defined by the direction of the wearable display based on the translational movement.

According to a third aspect, it is provided a computer program for calibrating a transparent wearable display configured to be used in parallel with an external display. The computer program comprises computer program code which, when executed on a calibration device causes the calibration device to: a processor; and a memory storing instructions that, when executed by the processor, cause the calibration device to: perform a first calibration to define an indicated position on the external display at least partly based on a direction of the wearable display; determine an indicated position on the external display, based on the direction of the wearable display, the indicated position corresponding to a user interface element shown on the external display; determine an element position on the external display corresponding to a centre position of the user interface element; and perform a translational adjustment of calibration of how the indicated position is determined on the external display based on the direction of the wearable display, to move the indicated position closer to the element position.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIGS. 2A-B are schematic diagrams illustrating embodiments of where the calibration device can be implemented;

FIG. 3 is a schematic diagram illustrating how an indicated position is shown on the external display, based on the direction of the wearable display;

FIG. 4 is a schematic diagram illustrating one way of calibrating the transparent wearable display where the indicated position is shown on the external display, based on sequentially shown calibration markers;

FIG. 5 is a schematic diagram illustrating one way of calibrating the transparent wearable display where the indicated position is shown on the external display, based on nudging the indicating position towards the centre of an indicated user interface element;

FIGS. 6A-C are schematic diagrams illustrating one way of calibrating the transparent wearable display where the indicated position is shown on the external display, based on rendering areas with different luminance that is detected by the wearable display;

FIG. 7 is a schematic diagram illustrating one way of calibrating the transparent wearable display where the indicated position is shown on the external display, based on calibration markers that are shown simultaneously;

FIGS. 8A-F are flow charts illustrating embodiments of methods for calibrating a transparent wearable display configured to be used in parallel with an external display;

FIG. 9 is a schematic diagram illustrating components of the calibration device of FIGS. 2A-B according to one embodiment;

FIG. 10 is a schematic diagram showing functional modules of the calibration device of FIGS. 2A-B according to one embodiment; and

FIG. 11 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, calibration of a wearable display, in relation to an external display, is provided. The calibration occurs when the user activates a user interface element on the external display using the direction of the wearable display. The calibration is nudged based on the assumption that (on average) the user is directing the wearable display towards the centre of the user interface element. Additional calibration is also provided, based on luminance detection, calibration markers and/or angle of arrival/angle of departure determinations. By basing the calibration on both the wearable device and the external display, the calibration is both accurate and convenient for the user, resulting in improved calibration.

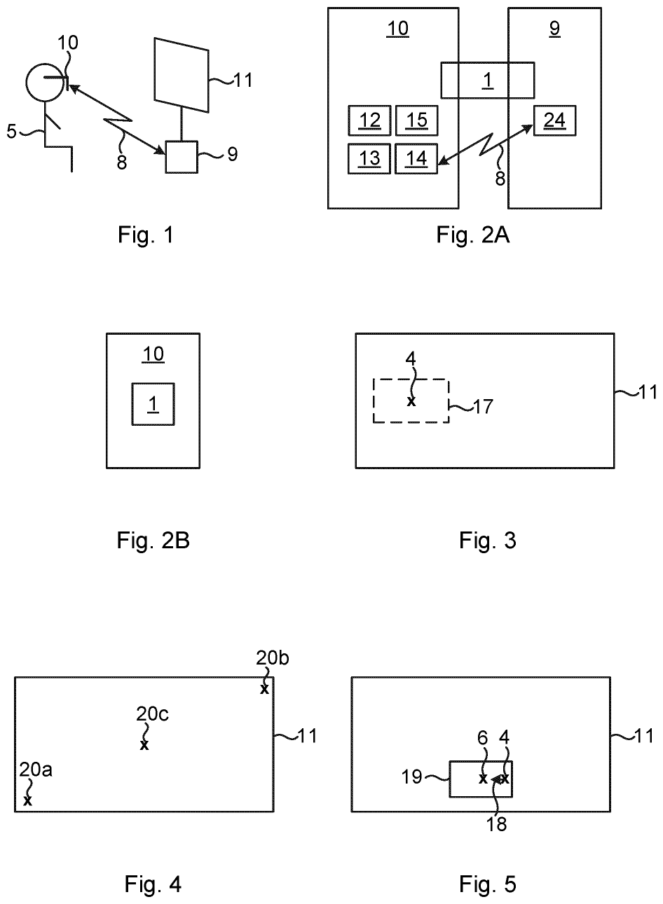

FIG. 1 is a schematic diagram illustrating an environment in which embodiments presented herein can be applied.

A user 5 is using a computer 9 and an external display 11 connected to the computer 9. The computer 9 can e.g. be a stationary computer, a laptop computer, an all-in-one computer (in which case the computer 9 and the external display 11 are combined in a single device), game console, etc. The user 5 also wears a wearable display 10, e.g. in the form of smart glasses with transparent rendering of content. Alternatively, the wearable display can be combined in a single device together with an audio headset, such as those commonly used for computer games. The external display 11 is external to the wearable display 10. The wearable display 10 can be designed or configured to be seen by one or two eyes. The wearable display 10 can augment main content shown on the external display 11. The wearable display 10 can e.g. be implemented using waveguide, micro LCD (Liquid Crystal Display), micro OLED (Organic Light Emitting Diode) or any other suitable display technology for see-through applications. It is to be noted that the wearable display 10 disclosed herein does not rely on tracking eye movement, also known as gaze tracking.

The wearable display 10 and the computer 9 can communicate with each other over a communication channel 8, which can be a short-range wireless channel such as based on Wi-Fi, Bluetooth, Bluetooth Low Energy (BLE), etc. Alternatively or additionally, the communication channel is based on a wired connection, e.g. USB (Universal Serial Bus) Alternatively or additionally, the communication channel 8 is based on communication via a wide area network, such as the Internet.

FIGS. 2A-B are schematic diagrams illustrating embodiments of where the calibration device 1 can be implemented. In FIG. 2A, part of the calibration device 1 is implemented in the wearable display 10 and part of the calibration device 1 is implemented in the computer 9. It is to be noted that the computer 9 can in itself be distributed, partly being implemented locally and partly being implemented in a remote server, also known as ‘the cloud’.

The wearable display 10 comprises an Inertial Measurement Unit (IMU) 15. The IMU 15 can e.g. comprise an accelerometer in three dimensions and a gyroscope in three dimensions. By double integrating the acceleration over time, a position is determined. However, due to noise and inaccuracies in digitisation and/or calculations, the position determination tends to drift over time, also known as sensor drift. This is where the calibration comes in, which corrects for any sensor drift that may have occurred.

The wearable display 10 is here illustrated comprising an optional first radio transceiver 14. The computer 9 is illustrated comprising an optional second radio transceiver 24. The first and second radio transceivers 14, 24 can communicate with each other over the communication channel 8. Optionally, the first and second radio transceivers 14, 24, can determine Angle of Arrival (AoA) and/or Angle of Departure (AoD) relative to each other based on timing differences in signal reception using two or more antennas. As explained in more detail below, the AoA/AoD can be used to calibrate the wearable display 10.

Furthermore, the wearable display 10 is here shown comprising an optional narrow-beam light sensor 12. The narrow-beam light sensor 12 can detect luminance in the direction that the wearable display 10 is directed, i.e. where the user 5 is directed when wearing the wearable display 10. The light detection is narrow beam (e.g. detecting light only two degrees, one degree, or even less from the direction in which the wearable display 10 is directed) to capture luminance only in a very small area in which the wearable display 10 is directed. As described in more detail below, the narrow-beam light sensor 12 can be used in calibrating the wearable display 10.

As mentioned above, embodiments presented herein do not rely on eye-tracking. In other words, the direction of the wearable display 10 is based on IMU 15 readings, combined with the calibration as described below.

Additionally, the wearable display 10 is here shown comprising an optional camera 13. The camera 13 can be used to detect calibration markers 20a-c for calibration as described in more detail below.

By distributing the calibration device 1, and thus its processing, over both the wearable display 10 and the computer 9, a lot of heavy processing can be offloaded from the wearable display 10 to the computer 9. This greatly reduces processing and power requirements of the wearable display 10. Hence, the wearable display 10 can be provided with components that are of lower capacity, reducing power consumption and cost. An effect of this is that, when the wearable display 10 is battery powered, the battery can be smaller and cheaper and/or battery use time is extended.

In FIG. 2B an embodiment is shown where the calibration device is implemented completely in the wearable device 10.

FIG. 3 is a schematic diagram illustrating how an indicated position 4 is shown on the external display 11, based on the direction of the wearable display 10.

The external display 11 shows main content from the computer 9 as known in the art per se. The main content can e.g. be a computer game, media rendering, web browsing, office work or any other type of content generated by the computer 9. In parallel, when the user 5 is wearing the wearable display 10, the direction of the wearable display 10 is determined using its IMU 15 and previous calibration. An indicated position 4 on the external display 11 is thus at least partly based on a direction of the wearable display 10. The indicated position 4 can be based also on the relative position between the wearable display 10 and the external display 11. Auxiliary content 17 can be rendered by the wearable device 10 and depends on the indicated position 4.

It is to be noted that need for accuracy of the calibration depends on the main content on the external display 11 and the auxiliary content 17 of the wearable device 10. For instance, if the main content is a first-person shooter computer game and the auxiliary content is an x-ray vision at the edge of a wall, accuracy is important since the edge needs to be accurately correlated between the external display 11 and the wearable display 10 as it is very noticeable to the user 5. On the other hand, if the main content is a first-person shooter computer game and the auxiliary content is game statistics displayed on the side, accuracy of calibration is of less importance.

FIG. 4 is a schematic diagram illustrating one way of calibrating the transparent wearable display where the indicated position is shown on the external display 11, based on sequentially shown calibration markers 20a-c. In this calibration, a first calibration marker 20a is shown close to a corner of the external display 11. The user 5 is instructed to direct the wearable display 10 to the first calibration marker 20a, optionally by aligning a directional marker rendered using the wearable display 10 with the first calibration marker 20a. The same procedure is repeated for a second calibration marker 20b and a third calibration marker 20c. When these known alignments are recorded, the calibration can be based on these alignments.

FIG. 5 is a schematic diagram illustrating one way of calibrating the transparent wearable display where the indicated position 4 is shown on the external display 11, based on nudging the indicating position 4 towards the centre 6 of an indicated user interface element 19.

This calibration can be performed whenever a user interface element 19 is rendered on the external display 11. The user interface element 19 can e.g. be a button, an item of selection etc. which is triggered by the user 5 directing the wearable display 10 to the user interface element 19.

When the user activates the user interface element 19, an offset of the current indicated position 4 of direction, relative to the element position 6 (on the external display) that corresponds to a centre position of the user interface element 19 is determined. The calibration is then performed by nudging the indicated position 4 in a direction 18 towards the element position 6. In other words, the calibration results in the indicated position 4 being moved slightly towards the element position 6 for when the indicated position 4 is determined.

This calibration is based on the presumption that, on average, the user will direct the wearable display 10 towards the element position 6. Using this calibration, the nudging can occur every time a user interface element 6 on the external display 11 is activated using the direction of the wearable display 11, achieving constant, gradual nudging calibration to counteract any sensor drifting that may occur. In this calibration, the user does not need to be prompted for any explicit calibration user interaction, since the user interaction with the user interface element 16 is exploited instead. The nudging can occur every n frames, where n can be any natural number (including 1 for the nudging to occur every frame). The number n can depend on a distance between the indicated position 4 and the element position 6.

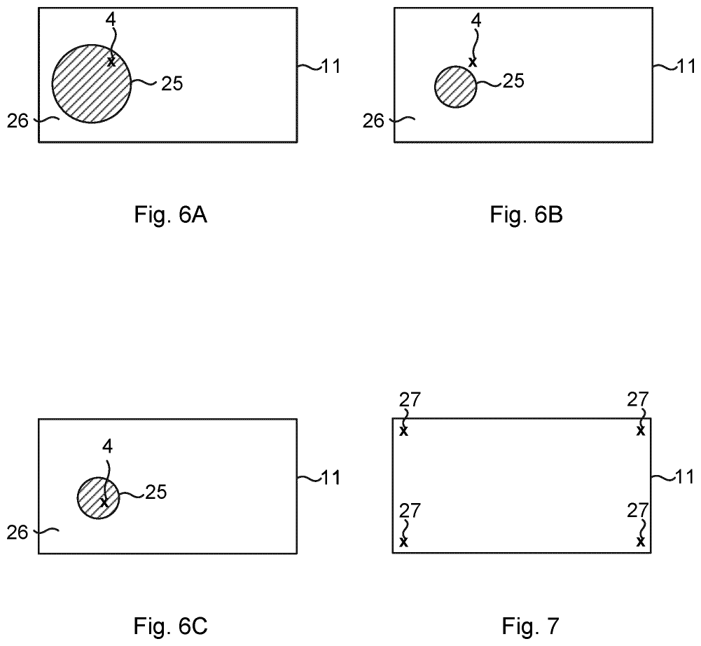

FIGS. 6A-C are schematic diagrams illustrating one way of calibrating the transparent wearable display 10 where the indicated position is shown on the external display 11, based on rendering areas with different luminance that is detected by the wearable display 10. In this embodiment, the wearable display 10 comprises the narrow-beam light sensor 12 described above.

The calibration device here renders an image on the external display 11 that comprises a high-luminance area 25 and a low-luminance area 26. It is to be noted that which one of the areas 25, 26 is high and low luminance can be reversed. This rendering can be interjected as one or a small number of frames within main content, to minimise disruption to the user 5 consuming the main content.

Looking first to FIG. 6A, the indicated position 4 is shown on the external display 11. In FIG. 6A, the indicated position 4 is within the high luminance area 25. The narrow-beam light sensor 12 detects that the direction of the wearable display 10 is within the high luminance area 25. The calibration device can thus deduce that the direction of wearable device 10 is determined with an accuracy that at least corresponds to the size of the high luminance area 25.

After successful correspondence between luminance and indicated position 4 in the high luminance area of FIG. 6A, a smaller high-luminance area 25 is rendered on the external display, as shown in FIG. 6B. Here, however, the indicated position 4 is outside the high-luminance area 25.

Due to the discrepancy, calibration needs to be adjusted. The calibration device 1 adjusts the calibration, as shown in FIG. 6C, such that the indicated position is within the high-luminance area 25.

It is to be noted that the high-luminance area 25 can be a gradient of luminance, e.g. with increasing luminance towards the centre of the high-luminance area 25. This allows the calibration device 1 to determine more accurately the direction of the wearable display 10. In such an embodiment, the luminance detection of the light sensor may need to be calibrated separately, initially.

FIG. 7 is a schematic diagram illustrating one way of calibrating the transparent wearable display 10 where the indicated position is shown on the external display 11, based on calibration markers 27 that are shown simultaneously. The calibration markers 27 are shown in different parts of the external display 11, e.g. close to the corners to achieve a relatively large distance between the calibration markers 27. In this embodiment, the wearable display 10 comprises the camera 13 described above.

In this embodiment, the camera captures an image showing the external display 11 and the calibration markers 27 rendered on the external display 11. The calibration markers 27 can be of any suitable type that is detectable by the camera 13, and does not need to be visible for the user 5. For instance, the calibration markers 27 can be a pattern that the camera 13 easily can detect, or a specific colouring of one or more pixels that the camera 13 easily can detect by filtering the colours, but of a pattern that is not conspicuous or disturbing for the user 5. The pattern is shown for one or several frames so that the camera 13 can detect the calibration markers 27.

The actual direction of the wearable display 10 can then be calculated based on the distances between the calibration markers 27 and angles between lines to different calibration markers 27 from a particular calibration marker 27.

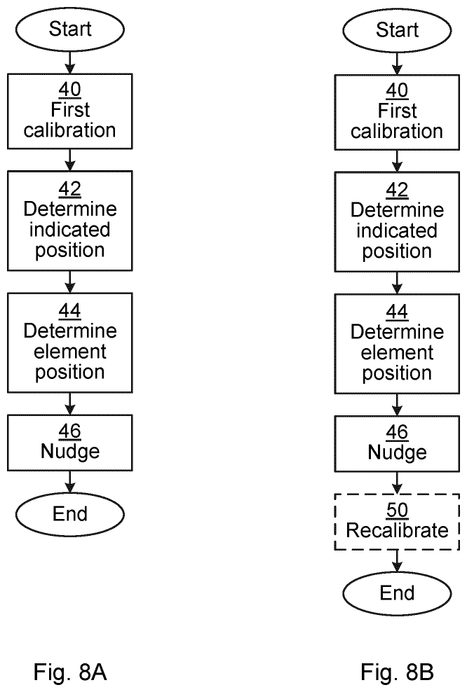

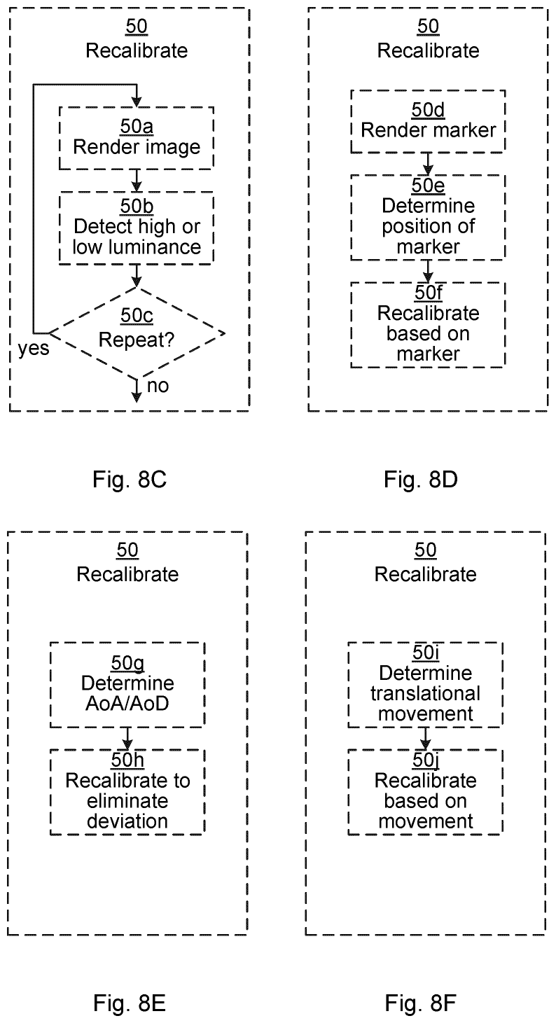

FIGS. 8A-F are flow charts illustrating embodiments of methods for calibrating a transparent wearable display 10 configured to be used in parallel with an external display 11.

In a first calibration step 40, the calibration device 1 performs a first calibration to define an indicated position 4 on the external display 11 at least partly based on a direction of the wearable display 10. This calibration can e.g. be based on the calibration markers and user instructions described above with reference to FIG. 4. Any other suitable calibration could also be applied here.

In a determine indicated position step 42, the calibration device 1 determines an indicated position 4 on the external display, based on the direction of the wearable display 10. The indicated position 4 corresponds to a user interface element 19 shown on the external display 11.

In a determine element position step 44, the calibration device 1 determines an element position 6 on the external display 11 corresponding to a centre position of the user interface element 19.

In a nudge step 46, the calibration device 1 nudges the calibration by performing a translational adjustment of calibration of how the indicated position 4 is determined on the external display 11 based on the direction of the wearable display 10, as shown in FIG. 5 and described above. The translation adjustment moves the indicated position closer to the element position 6.

The indicated position can be moved towards the element position 6 by a distance being determined as the distance between the indicated position 4 and the element position 6 multiplied by a nudging factor. The nudging factor can be a preconfigured constant or the nudging factor can depend on the distance between the indicated position 4 and the element position 6. Alternatively, the nudging factor can depend on the extent of the sensor drift between instances of calibration. For instance, the nudging factor can be calculated according to k*(distance between the indicated position and the element position), where k is a positive real number less than 1.

Looking now to FIG. 8B, only new or modified steps compared to FIG. 8A are described.

In an optional recalibrate step 50, the calibration device 1 recalibrates 50 how the indicated position 4 on the external display 11 is based on the direction of the wearable display 10. This can occur when the sensor drift is expected to be (or is measured to be) large enough to make a difference for the application of the wearable display 10.

Optionally, the recalibrate step 50 is repeated. In each iteration of the recalibrate step 50, a time interval until the next iteration of the recalibrate step 50 is determined based on a most recently determined sensor drift. A base time interval can e.g. be ⅙s. If the sensor drift is larger than a threshold level (or increases more than a threshold amount), the time interval is decreased to quicker adapt to the sensor drift. On the other hand, if the sensor drift is smaller than a threshold level (or decreases more than a threshold amount), the time interval is increased in order not to spend excess resources on calibration.

Looking now to FIG. 8C, this is a flow chart illustrating optional sub-steps of the recalibrate step 50 of FIG. 8B according to one embodiment. This embodiment corresponds to the embodiment illustrated in FIGS. 6A-C and described above.

In an optional render image sub-step 50a, the calibration device 1 renders, on the external display 11, an image comprising a high-luminance area 25 and a low-luminance area 26.

Optionally, for each iteration of this step, the calibration device 1 renders, over time, a smaller area, being a high-luminance area 25 or a low-luminance area 26 in the direction that the wearable display 10 is directed. With the smaller area, accuracy is improved. The area, being a high-luminance area 25 or a low-luminance area 26, may need to be moved for each iteration if the light sensor does not detect this area.

The rendered image can be interjected as a single frame in main content shown on the external display 11. The main content can be content from the computer device 9 connected to the external display 11.

In an optional detect high or low luminance sub-step 50b, the calibration device 1 detects, using a narrow-beam light sensor 12, whether the wearable display 10 is directed to the high-luminance area or the low-luminance area. The narrow-beam light sensor 12 is fixedly mounted in relation to the wearable display 10, and can form part of the wearable display 10.

In an optional conditional repeat step 50c, the calibration device 1 determines whether to repeat the processing. This determination can be affirmative until the direction of the wearable display 10 is determined with sufficient accuracy. If the determination is to repeat, the method returns to the render image step 50a, which is then performed to render a different image. When the determination is negative, i.e. the repeating is not to be performed, the recalibrate step 50 ends.

Looking now to FIG. 8D, this is a flow chart illustrating optional sub-steps of the recalibrate step 50 of FIG. 8B according to one embodiment. This embodiment corresponds to the embodiment illustrated in FIG. 7 and described above.

In an optional render marker sub-step 50d, the calibration device 1 renders, on the external display 11, a calibration marker 27. The calibration marker 27 can be overlayed in main content shown on the external display 11.

In an optional determine position of marker sub-step 50e the calibration device 1 determines, using a camera 13, a position of the calibration marker 27 in relation to the direction of the wearable display 10. The camera 13 is fixedly mounted in relation to the wearable display 10, and can e.g. form part of the wearable display 10.

In an optional recalibrate based on marker sub-step 50f, the calibration device 1 recalibrates how the indicated position 4 on the external display 11 is based on the direction of the wearable display 10 based on the position of the calibration marker 27 in relation to the direction of the wearable display 10.

Looking now to FIG. 8E, this is a flow chart illustrating optional sub-steps of the recalibrate step 50 of FIG. 8B according to one embodiment.

In an optional determine AoA/AoD sub-step 50g, the calibration device 1 determines, using an determination of angle-of-arrival and/or angle-of-departure between a first radio transceiver 14 and a second radio transceiver 24, a deviation of how the indicated position 4 on the external display 11 is defined by the direction of the wearable display 10 compared to a previously calibrated state. The first radio transceiver 14 is fixedly mounted in relation to the wearable display 10 and can e.g. form part of the wearable display 10. The second radio transceiver 24 is fixedly mounted in relation to the external display 11. For instance, the second radio transceiver 24 can form part of the external display 11 or can form part of the computer 9 connected to the external display 11. The first and second radio transceivers 14, 24 can e.g. communicate using Bluetooth, which provides support for AoA and AoD determinations.

The angle between the wearable display 10 and the external display 11/computer thus determined. When the user moves his head, the changes of the angle is detected using AoA/AoD, by comparing with an estimated direction from the IMU-based algorithms. If there is a sensor drift above a certain threshold in the IMU-based algorithm relative to what is determined from the AoA mechanism, the recalibration occurs. Depending on the radio frequency, antenna configuration and AoA/AoD algorithm, various AoA/AoD resolution can be achieved. For example, with an antenna array installed on the external display 11 or computer 9, by applying AoA multiple signal classification algorithm, the change of the angle in less one degree can be detected.

In an optional recalibrate to eliminate deviation sub-step 50h, the calibration device 1 recalibrates to eliminate the deviation that is determined in the preceding sub-step.

Looking now to FIG. 8F, this is a flow chart illustrating optional sub-steps of the recalibrate step 50 of FIG. 8B according to one embodiment.

In an optional determine translational movement sub-step 50i, the calibration device 1 determines, using an IMU 15, a translational movement of the wearable display 10 in relation to the external monitor 11. The IMU 15 is fixedly mounted in relation to the wearable display 10 and can e.g. form part of the wearable display 10. This translational movement can e.g. occur if the user moves his head.

In an optional recalibrate based on movement sub-step 50j, the calibration device 1 recalibrates how the indicated position 4 on the external display 11 is defined by the direction of the wearable display 10 based on the translational movement.

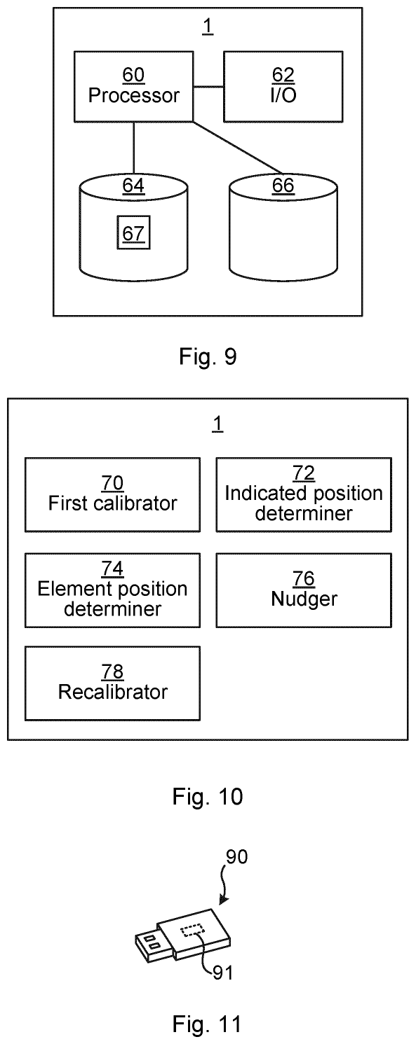

FIG. 9 is a schematic diagram illustrating components of the calibration device 1 of FIGS. 2A-B according to one embodiment. It is to be noted that the calibration device 1 can be implemented by sharing one or more of the mentioned components with a host device. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIGS. 8A-F above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The calibration device 1 further comprises an I/O interface 62 for communicating with external and/or internal entities.

Other components of the calibration device 1 are omitted in order not to obscure the concepts presented herein.

FIG. 10 is a schematic diagram showing functional modules of the calibration device 1 of FIGS. 2A-B according to one embodiment. The modules are implemented using software instructions such as a computer program executing in the calibration device 1. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 8A-F.

A first calibrator 70 corresponds to step 40. An indicated position 4 determiner 72 corresponds to step 42. An element position determiner 74 corresponds to step 44. A nudger 76 corresponds to step 46. A recalibrator 78 corresponds to step 50.

FIG. 11 shows one example of a computer program product 90 comprising computer readable means. On this computer readable means, a computer program 91 can be stored, which computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 9. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for calibrating a transparent wearable display configured to be used in parallel with an external display, the method being performed by a calibration device, the method comprising the steps of:
performing a first calibration to define an indicated position on the external display at least partly based on a direction of the wearable display;
determining an indicated position on the external display, based on the direction of the wearable display, the indicated position corresponding to a user interface element shown on the external display;
determining an element position on the external display corresponding to a centre position of the user interface element; and
performing a translational adjustment of calibration of how the indicated position is determined on the external display based on the direction of the wearable display, to move the indicated position closer to the element position.

2. The method according to claim 1, wherein the step of performing a translational calibration comprises moving the indicated position towards the element position, by a distance being the distance between the indicated position and the element position multiplied by a nudging factor.

3. The method according to claim 1, further comprising:
recalibrating how the indicated position on the external display is based on the direction of the wearable display.

4. The method according to claim 3, wherein the step of recalibrating is repeated, and wherein, in each iteration of the step of recalibrating, a time interval until the next iteration of the step of recalibrating is determined based on a most recently determined sensor drift.

5. The method according to claim 3, wherein the step of recalibrating comprises the sub-steps of:
rendering, on the external display, an image comprising a high-luminance area and a low-luminance area;
detecting, using a narrow-beam light sensor, fixedly mounted in relation to the wearable display, whether the wearable display is directed to the high-luminance area or the low-luminance area; and
repeating the rendering, with a different image, and detecting until the direction of the wearable display is determined with sufficient accuracy.

6. The method according to claim 5, wherein for each iteration, the step of rendering an image comprises rendering, over time, a smaller area, being a high-luminance area or a low-luminance area in the direction that the wearable display is directed.

7. The method according to claim 5, wherein the step of rendering an image comprises interjecting the image as a single frame in main content shown on the external display.

8. The method according to claim 3, wherein the step of recalibrating comprises the sub-steps of:
rendering, on the external display, a calibration marker;
determining, using a camera, fixedly mounted in relation to the wearable display, a position of the calibration marker in relation to the direction of the wearable display; and
recalibrating how the indicated position on the external display is based on the direction of the wearable display based on the position of the calibration marker in relation to the direction of the wearable display.

9. The method according to claim 8, wherein the step of rendering a calibration marker comprises overlaying the calibration marker in main content shown on the external display.

10.-11. (canceled)

12. A calibration device for calibrating a transparent wearable display configured to be used in parallel with an external display, the calibration device comprising:
a processor; and
a memory storing instructions that, when executed by the processor, cause the calibration device to:
perform a first calibration to define an indicated position on the external display at least partly based on a direction of the wearable display;
determine an indicated position on the external display, based on the direction of the wearable display, the indicated position corresponding to a user interface element shown on the external display;
determine an element position on the external display corresponding to a centre position of the user interface element; and
perform a translational adjustment of calibration of how the indicated position is determined on the external display based on the direction of the wearable display, to move the indicated position closer to the element position.

13. The calibration device according to claim 12, wherein the instructions to perform a translational calibration comprise instructions that, when executed by the processor, cause the calibration device to move the indicated position towards the element position, by a distance being the distance between the indicated position and the element position multiplied by a nudging factor.

14. The calibration device according to claim 12, further comprising instructions that, when executed by the processor, cause the calibration device to:
recalibrate how the indicated position on the external display is based on the direction of the wearable display.

15. The calibration device according to claim 14, wherein the instructions to recalibrate are repeated, and wherein, in each iteration of the instructions to recalibrate, a time interval until the next iteration of the instructions to recalibrate is determined based on a most recently determined sensor drift.

16. The calibration device according to claim 14, wherein the instructions to recalibrate comprises instructions to:
render, on the external display, an image comprising a high-luminance area and a low-luminance area;
detect, using a narrow-beam light sensor, fixedly mounted in relation to the wearable display, whether the wearable display is directed to the high-luminance area or the low-luminance area; and
repeat the instructions to render, with a different image, and to detect until the direction of the wearable display is determined with sufficient accuracy.

17. The calibration device according to claim 16, wherein for each iteration, the instructions to render an image comprise instructions that, when executed by the processor, cause the calibration device to render, over time, a smaller area, being a high-luminance area or a low-luminance area in the direction that the wearable display is directed.

18. The calibration device according to claim 16, wherein the instructions to render an image comprises instructions that, when executed by the processor, cause the calibration device to interject the image as a single frame in main content shown on the external display.

19. The calibration device according to claim 14, wherein the instructions to recalibrate comprise the instructions that, when executed by the processor, cause the calibration device to:
render, on the external display, a calibration marker;
determine, using a camera, fixedly mounted in relation to the wearable display, a position of the calibration marker in relation to the direction of the wearable display; and
recalibrate how the indicated position on the external display is based on the direction of the wearable display based on the position of the calibration marker in relation to the direction of the wearable display.

20. The calibration device according to claim 19, wherein the instructions to render a calibration marker comprise instructions that, when executed by the processor, cause the calibration device to overlay the calibration marker in main content shown on the external display.

21. The calibration device according to claim 14, wherein the instructions to recalibrate comprise instructions that, when executed by the processor, cause the calibration device to:
determine, using an determination of angle-of-arrival and/or angle-of-departure between a first radio transceiver, fixedly mounted in relation to the wearable display, and a second radio transceiver fixedly mounted in relation to the external display, a deviation of how the indicated position on the external display is defined by the direction of the wearable display compared to a previously calibrated state; and
recalibrate to eliminate the deviation.

22. The calibration device according to claim 14, wherein the instructions to recalibrate comprise instructions that, when executed by the processor, cause the calibration device to:
determine, using an inertial measurement unit, IMU, fixedly mounted in relation to the wearable display, a translational movement of the wearable display in relation to the external monitor; and
recalibrate how the indicated position on the external display is defined by the direction of the wearable display based on the translational movement.

23.-24. (canceled)
